(19) United States
(12) Patent Application Publication
(10) Pub. No.: US 2026/0292746 A1
(43) Pub. Date: Sep. 24, 2026

(54) REGISTRATION METHOD AND APPARATUS

(71) Applicant: BEIJING XIAOMI MOBILE SOFTWARE CO., LTD., Beijing (CN)

(72) Inventors: Qingyu LAI, Beijing (CN); Yumin WU, Beijing (CN); Huilong ZHANG, Beijing (CN); Weiwei LI, Beijing (CN)

(73) Assignee: BEIJING XIAOMI MOBILE SOFTWARE CO., LTD., Beijing (CN)

(21) Appl. No.: 19/475,633

(22) PCT Filed: Apr. 20, 2023
(86) PCT No.: PCT/CN2023/089616

§ 371 Date: Oct. 15, 2025

(51) Int. Cl. H04W 60/00

(52) U.S. Cl. CPC H04W 60/00

(57) ABSTRACT

A registration method is provided. A core network device receives a registration request message, the registration request message comprising an indication of whether a terminal supports an integrated sensing and communication capability; and the core network device sends a registration accept message, the registration accept message comprising an indication of whether the core network device supports the integrated sensing and communication capability.

### CROSS-REFERENCE TO RELATED APPLICATIONS

This application is a U.S. National Phase application of International Application No. PCT/CN2023/089616, filed on Apr. 20, 2023, the entire contents of which are incorporated herein by reference for all purposes.

### FIELD

The present disclosure relates to the field of communication technologies, and in particular relates to a registration method and apparatus.

### BACKGROUND

An integrated sensing and communication system (also called a unified sensing and communication system) is an important technical direction for the development of wireless communication. The main features of the integrated sensing and communication system are: on the one hand, a communication module and a sensing module in a device can share signal transmission and reception hardware to save hardware overhead; on the other hand, the device can realize the function of sensing the communication environment by detecting a communication signal transmission channel, such that the device can support an integrated sensing and communication capability. In the integrated sensing and communication system, a variety of sensing applications will be supported, including terminal positioning, environment sensing, posture recognition and the like, and correspondingly, a variety of types of terminals will be supported, including integrated sensing and communication devices.

### SUMMARY

In a first aspect, embodiments of the present disclosure provide a registration method, performed by a core network device, including:
receiving a registration request message, in which the registration request message includes an indication of whether a terminal supports an integrated sensing and communication capability; and
sending a registration accept message, in which the registration accept message includes an indication of whether the core network device supports the integrated sensing and communication capability.

In a second aspect, embodiments of the present disclosure provide another registration method, performed by an access network device, including:
receiving a registration request message sent by a terminal, in which the registration request message includes an indication of whether the terminal supports an integrated sensing and communication capability;
sending the registration request message to a core network device;
receiving a registration accept message sent by the core network device, in which the registration accept message includes an indication of whether the core network device supports the integrated sensing and communication capability; and
sending the registration accept message to the terminal.

In a third aspect, embodiments of the present disclosure provide yet another registration method, performed by a terminal, including:
sending a registration request message, in which the registration request message includes an indication of whether the terminal supports an integrated sensing and communication capability; and
receiving a registration accept message, in which the registration accept message includes an indication of whether a core network device supports the integrated sensing and communication capability.

In a fourth aspect, embodiments of the present disclosure provide a registration method, performed by a network device, including:
receiving a registration request message sent by a terminal, in which the registration request message includes an indication of whether the terminal supports an integrated sensing and communication capability; and
sending a registration accept message to the terminal, in which the registration accept message includes an indication of whether the network device supports the integrated sensing and communication capability.

In a fifth aspect, embodiments of the present disclosure provide another registration method, performed by a terminal, including:
sending a registration request message to a network device, in which the registration request message includes an indication of whether the terminal supports an integrated sensing and communication capability; and
receiving a registration accept message sent by the network device, in which the registration accept message includes an indication of whether the network device supports the integrated sensing and communication capability.

In a sixth aspect, embodiments of the present disclosure provide a communication device, including:
a transceiver module, configured to receive a registration request message, in which the registration request message includes an indication of whether a terminal supports an integrated sensing and communication capability;
the transceiver module is further configured to send a registration accept message, in which the registration accept message includes an indication of whether a core network device supports the integrated sensing and communication capability.

In a seventh aspect, embodiments of the present disclosure provide another communication device, including:
a transceiver module, configured to receive a registration request message sent by a terminal, in which the registration request message includes an indication of whether the terminal supports an integrated sensing and communication capability;
the transceiver module is further configured to send the registration request message to a core network device;
the transceiver module is further configured to receive a registration accept message sent by the core network device, in which the registration accept message includes an indication of whether the core network device supports the integrated sensing and communication capability; and the transceiver module is further configured to send the registration accept message to the terminal.

In an eighth aspect, embodiments of the present disclosure provide yet another communication device, including:
a transceiver module, configured to send a registration request message, in which the registration request message includes an indication of whether a terminal supports an integrated sensing and communication capability;
the transceiver module is further configured to receive a registration accept message, in which the registration accept message includes an indication of whether a core network device supports the integrated sensing and communication capability.

In a ninth aspect, embodiments of the present disclosure provide a communication device, including:
a transceiver module, configured to receive a registration request message sent by a terminal, in which the registration request message includes an indication of whether the terminal supports an integrated sensing and communication capability;
the transceiver module is further configured to send a registration accept message to the terminal, in which the registration accept message includes an indication of whether the network device supports the integrated sensing and communication capability.

In a tenth aspect, embodiments of the present disclosure provide a communication device, including:
a transceiver module, configured to send a registration request message to a network device, in which the registration request message includes an indication of whether the terminal supports an integrated sensing and communication capability;
the transceiver module is further configured to receive a registration accept message sent by the network device, in which the registration accept message includes an indication of whether the network device supports the integrated sensing and communication capability

In an eleventh aspect, embodiments of the present disclosure provide a communication system, including:
a core network device, configured to perform the method as described in the first aspect;
an access network device, configured to perform the method as described in the second aspect; and
a terminal, configured to perform the method as described in the third aspect.

In a twelfth aspect, embodiments of the present disclosure provide another communication system, including:
a network device configured to perform the method as described in the fourth aspect; and
a terminal configured to perform the method as described in the fifth aspect.

In a thirteenth aspect, embodiments of the present disclosure provide a communication device. The communication device has some or all of the functions of the core network device for implementing the method of the first aspect. For example, the functions of the communication device may have the functions in some or all of embodiments of the present disclosure, or may have the function for implementing any one of embodiments of the present disclosure independently. The functions may be implemented by hardware, or may be implemented by hardware executing corresponding software. The hardware or software includes one or more units or modules corresponding to the functions described above.

In a fourteenth aspect, embodiments of the present disclosure provide another communication device. The communication device has some or all of the functions of the access network device for implementing examples of the method of the second aspect. For example, the functions of the communication device may have the functions in some or all of embodiments of the present disclosure, or may have the function for implementing any one of embodiments of the present disclosure independently. The functions may be implemented by hardware, or may be implemented by hardware executing corresponding software. The hardware or software includes one or more units or modules corresponding to the functions described above.

In a fifteenth aspect, embodiments of the present disclosure provide another communication device. The communication device has some or all of the functions of the terminal for implementing examples of the method of the third aspect. For example, the functions of the communication device may have the functions in some or all of embodiments of the present disclosure, or may have the function for implementing any one of embodiments of the present disclosure independently. The functions may be implemented by hardware, or may be implemented by hardware executing corresponding software. The hardware or software includes one or more units or modules corresponding to the functions described above.

In a sixteenth aspect, embodiments of the present disclosure provide another communication device. The communication device has some or all of the functions of the network device for implementing examples of the method of the fourth aspect. For example, the functions of the communication device may have the functions in some or all of embodiments of the present disclosure, or may have the function for implementing any one of embodiments of the present disclosure independently. The functions may be implemented by hardware, or may be implemented by hardware executing corresponding software. The hardware or software includes one or more units or modules corresponding to the functions described above.

In a seventeenth aspect, embodiments of the present disclosure provide another communication device. The communication device has some or all of the functions of the terminal for implementing examples of the method of the fifth aspect. For example, the functions of the communication device may have the functions in some or all of embodiments of the present disclosure, or may have the function for implementing any one of embodiments of the present disclosure independently. The functions may be implemented by hardware, or may be implemented by hardware executing corresponding software. The hardware or software includes one or more units or modules corresponding to the functions described above.

In an eighteenth aspect, embodiments of the present disclosure provide a communication device including a processor which, when invoking a computer program in a memory, performs the method of the first aspect described above.

In a nineteenth aspect, embodiments of the present disclosure provide a communication device including a processor which, when invoking a computer program in a memory, performs the method of the second aspect described above.

In a twentieth aspect, embodiments of the present disclosure provide a communication device including a processor which, when invoking a computer program in a memory, performs the method of the third aspect described above.

In a twenty-first aspect, embodiments of the present disclosure provide a communication device including a processor which, when invoking a computer program in a memory, performs the method of the fourth aspect described above.

In a twenty-second aspect, embodiments of the present disclosure provide a communication device including a processor which, when invoking a computer program in a memory, performs the method of the fifth aspect described above.

In a twenty-third aspect, embodiments of the present disclosure provide a communication device, which includes a processor and a memory. A computer program is stored in the memory, and the processor is configured to execute the computer program stored in the memory to cause the communication device to implement the method of the first aspect described above.

In a twenty-fourth aspect, embodiments of the present disclosure provide a communication device, which includes a processor and a memory. A computer program is stored in the memory, and the processor is configured to execute the computer program stored in the memory to cause the communication device to implement the method of the second aspect described above.

In a twenty-fifth aspect, embodiments of the present disclosure provide a communication device, which includes a processor and a memory. A computer program is stored in the memory, and the processor is configured to execute the computer program stored in the memory to cause the communication device to implement the method of the third aspect described above.

In a twenty-sixth aspect, embodiments of the present disclosure provide a communication device, which includes a processor and a memory. A computer program is stored in the memory, and the processor is configured to execute the computer program stored in the memory to cause the communication device to implement the method of the fourth aspect described above.

In a twenty-seventh aspect, embodiments of the present disclosure provide a communication device, which includes a processor and a memory. A computer program is stored in the memory, and the processor is configured to execute the computer program stored in the memory to cause the communication device to implement the method of the fifth aspect described above.

In a twenty-eighth aspect, embodiments of the present disclosure provide a communication device, which includes a processor and an interface circuit. The interface circuit is configured to receive code instructions and transmit the code instructions to the processor; and the processor is configured to run the code instructions to cause the device to perform the method of the first aspect described above.

In a twenty-ninth aspect, embodiments of the present disclosure provide a communication device, which includes a processor and an interface circuit. The interface circuit is configured to receive code instructions and transmit the code instructions to the processor; and the processor is configured to run the code instructions to cause the device to perform the method of the second aspect described above.

In a thirtieth aspect, embodiments of the present disclosure provide a communication device, which includes a processor and an interface circuit. The interface circuit is configured to receive code instructions and transmit the code instructions to the processor; and the processor is configured to run the code instructions to cause the device to perform the method of the third aspect described above.

In a thirty-first aspect, embodiments of the present disclosure provide a communication device, which includes a processor and an interface circuit. The interface circuit is configured to receive code instructions and transmit the code instructions to the processor; and the processor is configured to run the code instructions to cause the device to perform the method of the fourth aspect described above.

In a thirty-second aspect, embodiments of the present disclosure provide a communication device, which includes a processor and an interface circuit. The interface circuit is configured to receive code instructions and transmit the code instructions to the processor; and the processor is configured to run the code instructions to cause the device to perform the method of the fifth aspect described above.

In a thirty-third aspect, embodiments of the present disclosure provide a computer-readable storage medium configured to store instructions for a core network device as described above that, when executed, cause the core network device to perform the method of the first aspect described above.

In a thirty-fourth aspect, embodiments of the present disclosure provide a readable storage medium configured to store instructions for an access network device as described above that, when executed, cause the access network device to perform the method of the second aspect described above.

In a thirty-fifth aspect, embodiments of the present disclosure provide a readable storage medium configured to store instructions for a terminal as described above that, when executed, cause the terminal to perform the method of the third aspect described above.

In a thirty-sixth aspect, embodiments of the present disclosure provide a readable storage medium configured to store instructions for a network device as described above that, when executed, cause the network device to perform the method of the fourth aspect described above.

In a thirty-seventh aspect, embodiments of the present disclosure provide a readable storage medium configured to store instructions for a terminal as described above that, when executed, cause the terminal to perform the method of the fifth aspect described above.

In a thirty-eighth aspect, the present disclosure further provides a computer program product including a computer program that, when run on a computer, causes the computer to perform the method of the first aspect described above.

In a thirty-ninth aspect, the present disclosure further provides a computer program product including a computer program that, when run on a computer, causes the computer to perform the method of the second aspect described above.

In a fortieth aspect, the present disclosure further provides a computer program product including a computer program that, when run on a computer, causes the computer to perform the method of the third aspect described above.

In a forty-first aspect, the present disclosure further provides a computer program product including a computer program that, when run on a computer, causes the computer to perform the method of the fourth aspect described above.

In a forty-second aspect, the present disclosure further provides a computer program product including a computer program that, when run on a computer, causes the computer to perform the method of the fifth aspect described above.

### BRIEF DESCRIPTION OF THE DRAWINGS

In order to more clearly illustrate embodiments of the present disclosure or the technical solutions in the related art, drawings to be used for the description of embodiments of the present disclosure or the related art are described below.

FIG. 1 is a schematic diagram illustrating an architecture of a communication system according to embodiments of the present disclosure.

FIG. 2 is a flowchart illustrating a registration method according to embodiments of the present disclosure.

FIG. 3 is a flowchart illustrating another registration method according to embodiments of the present disclosure.

FIG. 4 is a flowchart illustrating a registration method according to embodiments of the present disclosure.

FIG. 5 is a flowchart illustrating yet another registration method according to embodiments of the present disclosure.

FIG. 6 is a flowchart illustrating another registration method according to embodiments of the present disclosure.

FIG. 7 is a flowchart illustrating yet another registration method according to embodiments of the present disclosure.

FIG. 8 is a schematic block diagram illustrating a communication device according to embodiments of the present disclosure.

FIG. 9 is a schematic block diagram illustrating another communication device according to embodiments of the present disclosure.

### DETAILED DESCRIPTION

The embodiments of the present disclosure are described in detail below, with examples illustrated in the accompanying drawings. Identical or similar reference numerals throughout the drawings denote identical or similar components or components with identical or similar functions. The embodiments described below with reference to the drawings are exemplary and are intended to explain the present disclosure, and should not be construed as limiting the disclosure. In the description of the present disclosure, unless otherwise stated, “/” means “or”, for example, A/B may mean A or B. The term “and/or” used herein describes an associated relationship of associated objects, and means that there may be three relationships, for example, the expression “A and/or B” may represent the following three cases: A exists alone, A and B exist at the same time, and B exists alone.

Terms used in the embodiments of the present disclosure are only for the purpose of describing specific embodiments, but should not be construed to limit the present disclosure. As used in the embodiments of the present disclosure and the appended claims, “a/an”, “said” and “the” in singular forms are intended to include plural forms, unless clearly indicated in the context otherwise.

It should be understood that, although terms such as “first,” “second” and “third” may be used in the embodiments of the present disclosure for describing various information, these information should not be limited by these terms. These terms are only used for distinguishing information of the same type from each other. For example, first information may also be referred to as second information, and similarly, the second information may also be referred to as the first information, without departing from the scope of embodiments of the present disclosure. As used herein, the term “if” may be construed to mean “when” or “upon” or “in response to determining” depending on the context.

The “protocol” involved in embodiments of the present disclosure may refer to a standard protocol in the communication field, and may include, for example, an LTE protocol, an NR protocol, and related protocols applied to a future communication system, which is not limited in the present disclosure. Embodiments of the present disclosure list multiple implementations to clearly explain the technical solutions of embodiments of the present disclosure. Of course, those skilled in the art may understand that the multiple embodiments provided by embodiments of the present disclosure may be performed alone, or may be performed in combination with possible implementation manners in other embodiments, or may be performed in combination with any technical solution in the related art, which is not limited in embodiments of the present disclosure.

Description will be made in detail below to embodiments of the present disclosure. Examples of embodiments are illustrated in the accompanying drawings, in which, the same or similar numbers represent the same or similar elements. Embodiments described below with reference to the accompanying drawings are exemplary, which are intended to explain the present disclosure and do not be understood a limitation of the present disclosure.

FIG. 1 is a schematic diagram illustrating an architecture of a communication system provided in the present disclosure. The communication system may include multiple different networks, such as 5G, 6G or other future new mobile communication networks. FIG. 1 illustrates 5G as an example. As shown in FIG. 1, the system may include a 5G core network device 101, a 5G access network device 102 and a terminal 103. The number and form of devices illustrated in FIG. 1 are only used for example and do not constitute a limitation in embodiments of the disclosure, and two or more core network devices, two or more access network devices and two or more terminals may be included in an actual application. The communication system illustrated in FIG. 1 takes an example of including one 5G core network device 101, one 5G access network device 102 and one terminal 103.

It should be noted that the technical solution of embodiments of the disclosure may be applied to various communication systems, such as, a long term evolution (LTE) system, a 5th generation (5G) mobile communication system, a 5G new radio (NR) system, or another future new mobile communication system. As another example, the technical solution of the embodiments of the present disclosure may be applied to the Internet of Vehicles, such as vehicle-to-everything (V2X) communication, long term evolution-vehicle (LTE-V) communication, vehicle-to-vehicle (V2V) communication, and the like, or may be used in fields such as intelligent driving and intelligent networked vehicles.

The core network device in embodiments of the present disclosure is an entity for sending or receiving a signal on a network side. The core network device may include an access and mobility management function (AMF) network element, which is mainly responsible for a signaling processing part, that is, a control plane function, including access control, mobility management, attachment and de-attachment, and the like.

The access network device in embodiments of the present disclosure is an entity for sending or receiving a signal on a network side. For example, the access network device may be an evolved NodeB (eNB), a transmission reception point (TRP), a next generation NodeB (gNB) in an NR system, a base station in other future mobile communication systems, or an access node in a wireless fidelity (Wi-Fi) system. Detailed technologies and detailed device forms employed by the access network device are not limited in embodiments of the disclosure. The access network device provided in embodiments of the disclosure may be combined by a central unit (CU) and a distributed unit (DU). The CU may also be referred to as a control unit. A protocol layer of the access network device, such as the base station, may be separated by employing a CU-DU structure, in which, part of functions of the protocol layer are centrally controlled by the CU, while part or all of remaining functions of the protocol layer are distributed in the DU. The DU is controlled by the CU.

The terminal in embodiments of the present disclosure is an entity for receiving or sending a signal on a user side, such as, a mobile phone. The terminal may also be referred to as a terminal device, a user equipment (UE), a mobile station (MS), a mobile terminal (MT), or the like. The terminal may be an automobile with a communication function, a smart automobile, a mobile phone, a wearable device, a pad, a computer with a wireless transceiver function, a virtual reality (VR) terminal, an augmented reality (AR) terminal, a wireless terminal in industrial control, a wireless terminal in self-driving, a wireless terminal in a remote medical surgery, a wireless terminal in a smart grid, a wireless terminal in a transportation safety, a wireless terminal in a smart city, a wireless terminal in a smart home, and the like. Detailed technologies and detailed device forms employed by the terminal are not limited in embodiments of the disclosure.

It may be understood that the communication system described in embodiments of the present disclosure is for a purpose of more clearly illustrating the technical solution of embodiments of the present disclosure, but does not constitute a limitation on the technical solutions provided by embodiments of the present disclosure. Moreover, it is known by those skilled in the art that the technical solutions provided by embodiments of the present disclosure are also applicable to similar technical problems with the evolution of the system architecture and the emergence of new business scenarios.

The following is a detailed introduction to a registration method and apparatus provided in the present disclosure with reference to the accompanying drawings.

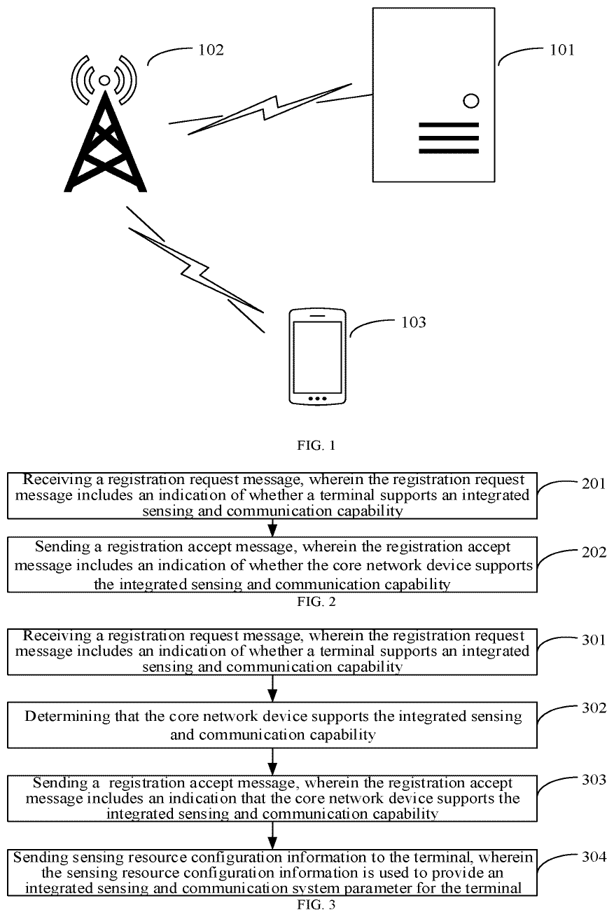

Referring to FIG. 2, FIG. 2 is a flowchart illustrating a registration method according to embodiments of the present disclosure. It should be noted that the method may be performed by a core network device. As shown in FIG. 2, the method may include but is not limited to following steps.

In step S201, a registration request message is received, in which the registration request message includes an indication of whether a terminal supports an integrated sensing and communication capability.

In an example of the present disclosure, the terminal may directly send the registration request message to the core network device.

In an example of the present disclosure, the registration request message is sent by the terminal to the core network device through an access network device. For example, the terminal may send the registration request message to the access network device, and the access network device may forward the registration request message to the core network device.

Supporting the integrated sensing and communication capability means supporting a communication capability as well as a sensing capability. For example, the terminal supports the integrated sensing and communication capability, that is, the terminal may support both the communication capability and the sensing capability. The terminal does not support an integrated sensing and communication intelligence, which may mean that the terminal supports the communication capability but does not support the sensing capability, and the terminal does not support the sensing capability, which may mean that the terminal does not have a capability of sensing a communication environment.

Optionally, in a registration procedure, the core network device may receive the registration request message sent by the terminal through the access network device, and the registration request message may include an indication of whether the terminal supports the integrated sensing and communication capability. As an example, the registration request message may be a REGISTRATION REQUEST message. For example, in a case where the terminal sends the REGISTRATION REQUEST message to the core network device through the access network device, indication information for indicating whether the terminal supports the integrated sensing and communication capability may be added to the REGISTRATION REQUEST message. The terminal supporting the integrated sensing and communication capability may be understood as the terminal may realize the capability of sensing the communication environment by detecting a communication signal transmission channel, and the terminal supporting the integrated sensing and communication capability may be understood as an integrated communication and sensing device.

In a possible implementation, the terminal sends the REGISTRATION REQUEST message to the access network device, and the indication information for indicating whether the terminal supports the integrated sensing and communication capability may be added to the REGISTRATION REQUEST message. In a case where the access network device receives the REGISTRATION REQUEST message sent by the terminal, the access network device may send the REGISTRATION REQUEST message to the core network device. Since information for indicating whether the terminal supports the integrated sensing and communication capability is added to the REGISTRATION REQUEST message, the core network device may determine whether the terminal supports the integrated sensing and communication capability according to the REGISTRATION REQUEST message received. As an example, the core network device described in the embodiments of the present disclosure may include an AMF network element, and the AMF network element may be an AMF selected by the access network device according to a globally unique temporary identifier (GUTI) sent by the terminal.

For example, the terminal initiates a registration, that is, the terminal sends an access network (AN) message to the access network device (such as a base station), and the message includes an AN parameter and the registration request message, in which the registration request message includes at least an indication of whether the terminal supports the integrated sensing and communication capability. The access network device performs an AMF selection. The AN sends an N2 message to the selected AMF, in which the N2 message includes an N2 parameter and the registration request message. In a case where the AMF receives the N2 message including the registration request message, the AMF executes an authentication server function (AUSF) selection to continue a subsequent registration procedure, in which the subsequent registration procedure (process steps other than a registration accept stage) is the same as the existing registration procedure in the related art, and therefore the present disclosure does not specifically limit this and will not repeat it here.

Optionally, in some embodiments of the present disclosure, a network registration type may include multiple different types of registrations. For example, taking a 5G network as an example, the registration type of the 5G network may include an initial registration, a mobility update registration, and a periodic registration. In an implementation, the registration procedure described in the embodiments of the present disclosure may include, but is not limited to, any one of the initial registration, the mobility update registration, and the periodic registration.

In an implementation, a first indication field having a given size is included in the registration request message, and the first indication field indicates whether the terminal supports the integrated sensing and communication capability. That is, an indication field is added to the registration request message in the registration procedure, and the indication field is used to identify whether the terminal supports the integrated sensing and communication capability (or has the integrated sensing and communication capability). For example, the indication field may be a bit, and a value of the bit is “1”, which may identify that the terminal supports the integrated sensing and communication capability. The value of the bit is “0”, which may identify that the terminal does not support the integrated sensing and communication capability. Alternatively, the value of the bit is “0”, which may indicate that the terminal supports the integrated sensing and communication capability; and the value of the bit is “1”, which may identify that the terminal does not support the integrated sensing and communication capability. It should be noted that the value of the bit may be another numerical value for identifying whether the terminal supports the integrated sensing and communication capability, which is not specifically limited in this disclosure and will not repeated here.

In step S202, a registration accept message is sent, in which the registration accept message includes an indication of whether the core network device supports the integrated sensing and communication capability.

In an example of the present disclosure, the registration accept message may be directly sent to the terminal.

In an example of the present disclosure, the registration accept message is sent by the core network device to the terminal through the access network device. For example, the core network device may send the registration accept message to the access network device, and the access network device may forward the registration accept message to the terminal.

In embodiments of the present disclosure, the core network device may determine whether it supports the integrated sensing and communication capability. The core network device supports the integrated sensing and communication capability, which means supporting the communication capability as well as the sensing capability. The core network device does not support the integrated sensing and communication intelligence, which may mean that the core network device supports the communication capability but does not support the sensing capability, and the core network device does not support the sensing capability, which may mean that the core network device does not have a capability of sensing a measurement configuration.

As an example, the core network device includes hardware parameters of all hardware in the core network device, and the core network device may determine whether the core network device supports the integrated sensing and communication capability through the hardware parameters, such as determining whether the core network device includes hardware providing sensing function and hardware providing communication function according to the hardware parameters. In this way, the core network device may determine whether the core network device includes hardware providing sensing function and hardware providing communication function according to its own hardware parameters. If the core network device includes the hardware providing the sensing function and the hardware providing the communication function, it is determined that the core network device supports the integrated sensing and communication capability. If the core network device does not include the hardware providing the sensing function and/or the hardware providing the communication function, it is determined that the core network device does not support the integrated sensing and communication capability.

Optionally, in a case where the core network device accepts a registration request in the registration procedure, the core network device may send the registration accept message to the terminal through the access network device, in which the registration accept message may include an indication of whether the core network device supports the integrated sensing and communication capability. That is, in a registration acceptance stage of the registration procedure, the present disclosure indicates whether the core network device supports the integrated sensing and communication capability by adding the indication information to the registration accept message. In this way, the terminal may know whether a network supports the integrated sensing and communication capability through the registration accept message, such that the terminal may subsequently obtain the configuration of the sensing measurement from the network and report a sensing measurement result to the network.

As an example, the accepted registration request may be a REGISTRATION ACCEPT message. For example, in a case where the core network device sends the REGISTRATION ACCEPT message to the terminal through the access network device, indication information for indicating whether the core network device supports the integrated sensing and communication capability may be added to the REGISTRATION ACCEPT message.

In a possible implementation, in a case where the core network device accepts the registration request, the core network device sends the REGISTRATION ACCEPT message to the access network device, and indication information for indicating whether the core network device supports the integrated sensing and communication capability may be added to the REGISTRATION ACCEPT message. In a case where the access network device receives the REGISTRATION ACCEPT message, the access network device may send the REGISTRATION ACCEPT message to the terminal. Since the information indicating whether the core network device supports the integrated sensing and communication capability is added in the REGISTRATION ACCEPT message, the terminal may determine whether the core network device supports the integrated sensing and communication capability according to the received REGISTRATION ACCEPT message. For example, in a case where the core network device supports the integrated sensing and communication capability, it may be determined that the access network device also supports the integrated sensing and communication capability.

In a possible implementation, in a case where the core network device determines that it supports the integrated sensing and communication capability, when the core network device accepts the registration request, the core network device may send the REGISTRATION ACCEPT message to the terminal through the access network device, and the indication information for indicating that the core network device supports the integrated sensing and communication capability may be added to the REGISTRATION ACCEPT message. In another possible implementation, in a case where the core network device determines that it does not support the integrated sensing and communication capability, when the core network device accepts the registration request, the core network device may send the REGISTRATION ACCEPT message to the terminal through the access network device, and the indication information for indicating that the core network device does not support the integrated sensing and communication capability may be added to the REGISTRATION ACCEPT message.

In an implementation, a second indication field having a given size is included in the registration accept message, and the second indication field indicates whether the core network device supports the integrated sensing and communication capability. That is, an indication field may be added to the registration accept message, and the indication field is used to identify whether the core network device supports the integrated sensing and communication capability (or has the integrated sensing and communication capability). For example, the indication field may be a bit, and a value of the bit is “1”, which may identify that the core network device supports the integrated sensing and communication capability. The value of the bit is “0”, which may identify that the core network device does not support the integrated sensing and communication capability. Alternatively, the value of the bit is “0”, which may indicate that the core network device supports the integrated sensing and communication capability; and the value of the bit is “1”, which may identify that the core network device does not support the integrated sensing and communication capability. It should be noted that the value of the bit may be another numerical value for identifying whether the core network device supports the integrated sensing and communication capability, which is not specifically limited in this disclosure and will not be repeated here.

By implementing the embodiments of the present disclosure, the information indicating whether the terminal supports the integrated sensing and communication capability and the information indicating whether the network supports the integrated sensing and communication capability may be added in the registration procedure, such that the terminal and the network may determine whether the other supports the integrated sensing and communication capability during the registration procedure, and such that when both the network and the terminal support the integrated sensing and communication capability, the network performs configuration of, for example, sensing measurement on the terminal, so as to realize the function of sensing the communication environment.

Referring to FIG. 3, FIG. 3 is a flowchart illustrating another registration method according to embodiments of the present disclosure. It should be noted that the method may be performed by a core network device. As shown in FIG. 3, the method may include but is not limited to following steps.

In step S301, a registration request message is received, in which the registration request message includes an indication of whether a terminal supports an integrated sensing and communication capability.

In embodiments of the present disclosure, step 301 may be implemented by any one of the embodiments of the present disclosure, which is not limited in embodiments of the present disclosure and will not be repeated here.

In step S302, it is determined that the core network device supports the integrated sensing and communication capability.

In a possible implementation, the core network device may determine whether the core network device includes hardware providing a sensing function and hardware providing a communication function according to its own hardware parameters. In a case where the core network device includes the hardware providing the sensing function and the hardware providing the communication function, it is determined that the core network device supports the integrated sensing and communication capability.

In step S303, a registration accept message is sent, in which the registration accept message includes an indication that the core network device supports the integrated sensing and communication capability.

In an example of the present disclosure, the registration accept message may be directly sent to the terminal.

In an example of the present disclosure, the registration accept message is sent by the core network device to the terminal through the access network device. For example, the core network device may send the registration accept message to the access network device, and the access network device may forward the registration accept message to the terminal.

In embodiments of the present disclosure, in a case where the core network device determines that it supports the integrated sensing and communication capability, it may be determined that the access network device also supports the integrated sensing and communication capability. In this way, in a case where the core network device accepts the registration request during the registration procedure, the core network device may send the registration accept message to the terminal through the access network device, in which the registration accept message may include an indication that the core network device supports the integrated sensing and communication capability. In this way, the terminal may know that the network supports the integrated sensing and communication capability through the registration accept message, such that the terminal may subsequently obtain a configuration of sensing measurement from the network and report a sensing measurement result to the network.

In step S304, sensing resource configuration information is sent to the terminal, in which the sensing resource configuration information is used to provide an integrated sensing and communication system parameter for the terminal.

In an example of the present disclosure, the sensing resource configuration information may be directly sent to the terminal.

In an example of the present disclosure, the sensing resource configuration information is sent by the core network device to the terminal through the access network device. For example, the core network device may send the sensing resource configuration information to the access network device, and the access network device may forward the sensing resource configuration information to the terminal.

In embodiments of the present disclosure, in a case where the core network device determines that it supports the integrated sensing and communication capability, it may be determined that the access network device also supports the integrated sensing and communication capability. In this way, the core network device may send the sensing resource configuration information to the terminal through a radio core network (RAN) message, and the sensing resource configuration information is used to provide the terminal with an integrated sensing and communication system parameter, such that the terminal may perform the sensing measurement through the integrated sensing and communication system parameter, and optionally, the terminal may also report the sensing measurement result to the network.

It should be noted that in embodiments of the present disclosure, the sensing resource configuration information may be stored in the core network device, or the sensing resource configuration information may also be stored in the access network device.

In an implementation, in a case where the sensing resource configuration information is stored on the core network device, the core network device may send the sensing resource configuration information to the access network device, such that the sensing resource configuration information is sent by the access network device to the terminal through system information (SI) or a radio resource control (RRC) message.

That is, in a case where the core network device determines that it supports the integrated sensing and communication capability and the sensing resource configuration information is stored on the core network device, the core network device may send the sensing resource configuration information to the access network device. The access network device sends the sensing resource configuration information to the terminal through the SI or the RRC message. For example, the access network device may send the sensing resource configuration information to the terminal in a form of broadcast through a system message. Alternatively, the access network device may also send the sensing resource configuration information to the terminal through the RRC message dedicated to the terminal. Alternatively, the access network may also send the sensing resource configuration information to the terminal in other ways, which is not limited in embodiments of the present disclosure and will not be repeated here.

In another implementation, in a case where the sensing resource configuration information is stored on the access network device, the core network device may send first information to the access network device, in which the first information indicates the access network device to send the sensing resource configuration information to the terminal.

That is, in a case where the core network device determines that it supports the integrated sensing and communication capability and the sensing resource configuration information is stored on the access network device, the core network device may send the first information to the access network device to indicate the access network device to send the stored sensing resource configuration information to the terminal. For example, the access network device may send the sensing resource configuration information to the terminal in the form of broadcast through a system message. Alternatively, the access network device may also send the sensing resource configuration information to the terminal through the RRC message dedicated to the terminal. Alternatively, the access network may also send the sensing resource configuration information to the terminal in other ways, which is not limited in embodiments of the present disclosure and will not be repeated here.

In a possible implementation, the integrated sensing and communication system parameter may include, but is not limited to, at least one of: a carrier frequency; a count of subcarriers; a count of estimating symbols; a bandwidth; a subcarrier spacing; a complete orthogonal frequency division multiplexing (OFDM) symbol period; a cyclic prefix period; an OFDM symbol period; or a cyclic prefix length. The term “at least one” refers to one or more, and “more” refer to two and more than two, such as three. In embodiments of the present disclosure, the integrated sensing and communication system parameters may include, but are not limited to: the carrier frequency; the number of subcarriers; the number of estimating symbols; the bandwidth; the subcarrier spacing; the complete OFDM symbol period; the cyclic prefix period; the OFDM symbol period; and the cyclic prefix length. It should be noted that the above-described embodiments are not exhaustive and are merely illustrative of some embodiments, and the above-described embodiments may be implemented alone or in combination, and the above-described embodiments are merely illustrative and do not specifically limit the scope of protection of the embodiments of the present disclosure.

As an example, it is assumed that the integrated sensing and communication system parameters may include: the carrier frequency; the number of subcarriers; the number of estimating symbols; the bandwidth; the subcarrier spacing; the complete OFDM symbol period; the cyclic prefix period; the OFDM symbol period; and the cyclic prefix length. The values of each parameter among the integrated sensing and communication system parameters are given in Table 1.

TABLE 1
Values of each parameter among the integrated
sensing and communication system parameters

| Parameter name | Value | |
|---|---|---|
| carrier frequency | 5 | GHz |
| count of subcarriers | 270 | RBs (3240) |
| count of estimating symbols | 280 | |
| bandwidth | 97.2 | MHz |
| subcarrier spacing | 30 | kHz |
| complete OFDM symbol period | 35.66 | us |
| cyclic prefix period | 2.33 | us |
| OFDM symbol period | 33.33 | us |

| | |
|---|---|
| cyclic prefix length | 226 |

It may be understood that each element in Table 1 above exists independently, and these elements are exemplarily listed in the same table, but it does not mean that all elements in the table must exist at the same time as shown in the table. The value of each element is independent of the value of any other element in Table 1. Therefore, it will be understood by those skilled in the art that the value of each element in Table 1 is an independent embodiment. It should also be noted that the values of respective parameters in the integrated sensing and communication system parameters given in Table 1 above are merely examples given for the convenience of those skilled in the art to understand the technical solutions of the present disclosure, and are not specific limitations of the present disclosure, that is, each parameter among the integrated sensing and communication system parameters may be other values, which is not particularly limited herein.

It is worth noting that the execution sequence of steps 303 and 304 described in the embodiments of the present disclosure may be: step 304 is executed first and then step 303 is executed, or step 303 is executed first and then step 304 is executed, or step 303 and step 304 are executed simultaneously. Optionally, in an implementation, step 303 may be executed first and then step 304 may be executed, that is, if both the core network device and the terminal support the integrated sensing and communication capability, after the registration of the terminal is completed, the core network device sends the sensing resource configuration information to the terminal through a radio access network message. This is not particularly limited in the present disclosure.

By implementing the embodiments of the present disclosure, the information indicating whether the terminal supports the integrated sensing and communication capability and the information indicating whether the network supports the integrated sensing and communication capability may be added in the registration procedure, such that the terminal and the network may determine whether the other supports the integrated sensing and communication capability during the registration procedure, and such that when both the network and the terminal support the integrated sensing and communication capability, the network performs configuration of, for example, sensing measurement on the terminal, to realize the function of sensing the communication environment.

It may be understood that the above-described embodiments describe an implementation of the registration method of the embodiments of the present disclosure from the core network device side. The embodiments of the present disclosure further provide a registration method, and an implementation of the registration method will be described below from the access network device side. Referring to FIG. 4, FIG. 4 is a flowchart illustrating a registration method according to embodiments of the present disclosure. It should be noted that the registration method of the embodiments of the present disclosure may be performed by an access network device. As shown in FIG. 4, the method may include but is not limited to following steps.

In step S401, a registration request message sent by a terminal is received, in which the registration request message includes an indication of whether a terminal supports an integrated sensing and communication capability.

In embodiments of the present disclosure, the terminal supports the integrated sensing and communication capability, that is, the terminal may support both the communication capability and the sensing capability. The terminal does not support an integrated sensing and communication capability, which may mean that the terminal supports the communication capability but does not support the sensing capability, and the terminal does not support the sensing capability, which may mean that the terminal does not have a capability of sensing a communication environment.

In a possible implementation, the terminal sends the REGISTRATION REQUEST message to the access network device, and indication information for indicating whether the terminal supports the integrated sensing and communication capability may be added to the REGISTRATION REQUEST message. The access network device may receive the REGISTRATION REQUEST message sent by the terminal.

Optionally, in some embodiments of the present disclosure, a network registration type may include multiple different types of registrations. For example, taking a 5G network as an example, the registration type of the 5G network may include an initial registration, a mobility update registration, and a periodic registration. In an implementation, the registration procedure described in the embodiments of the present disclosure may include, but is not limited to, any one of the initial registration, the mobility update registration, and the periodic registration.

In an implementation, a first indication field having a given size is included in the registration request message, and the first indication field indicates whether the terminal supports the integrated sensing and communication capability. That is, an indication field is added to the registration request message in the registration procedure, and the indication field is used to identify whether the terminal supports the integrated sensing and communication capability (or has the integrated sensing and communication capability). For example, the indication field may be a bit, and a value of the bit is “1”, which may identify that the terminal supports the integrated sensing and communication capability. The value of the bit is “0”, which may identify that the terminal does not support the integrated sensing and communication capability. Alternatively, the value of the bit is “0”, which may indicate that the terminal supports the integrated sensing and communication capability; and the value of the bit is “1”, which may identify that the terminal does not support the integrated sensing and communication capability. It should be noted that the value of the bit may be another numerical value for identifying whether the terminal supports the integrated sensing and communication capability, which is not specifically limited in embodiment of the present disclosure and will not be repeated here.

In step S402, the registration request message is sent to the core network device.

Optionally, in a case where the access network device receives the registration request message sent by the terminal, including the indication of whether the terminal supports the integrated sensing and communication capability, it may send the registration request message to the core network device. For example, the access network device may send the registration request message to the core network device through an N2 message.

In step S403, a registration accept message sent by the core network device is received, in which the registration accept message includes an indication of whether the core network device supports the integrated sensing and communication capability.

Optionally, in embodiments of the present disclosure, the core network device may determine whether it supports the integrated sensing and communication capability. In a case where the core network device accepts the registration request, the core network device may send the registration accept message to the access network device, which includes an indication of whether the core network device supports the integrated sensing and communication capability. For the implementation of this process, please refer to the implementation of the registration method described above from the core network device side, and the details are not be repeated here.

In an implementation, a second indication field having a given size is included in the registration accept message, and the second indication field indicates whether the core network device supports the integrated sensing and communication capability. That is, an indication field may be added to the registration accept message, and the indication field is used to identify whether the core network device supports the integrated sensing and communication capability (or has the integrated sensing and communication capability). For example, the indication field may be a bit, and a value of the bit is “1”, which may identify that the core network device supports the integrated sensing and communication capability. The value of the bit is “0”, which may identify that the core network device does not support the integrated sensing and communication capability. Alternatively, the value of the bit is “0”, which may indicate that the core network device supports the integrated sensing and communication capability; and the value of the bit is “1”, which may identify that the core network device does not support the integrated sensing and communication capability. It should be noted that the value of the bit may be another numerical value for identifying whether the core network device supports the integrated sensing and communication capability, which is not specifically limited in embodiments of the present disclosure and will not be repeated here.

In step S404, the registration accept message is sent to the terminal.

Optionally, the access network device may send the registration accept message to the terminal after receiving the registration accept message sent by the core network device. In this way, the terminal may know whether the core network device supports the integrated sensing and communication capability through the registration accept message.

It should be noted that with the present disclosure, the terminal may sense the network when registering with the network, and determine whether the network supports the integrated sensing and communication capability, such that if the network also supports the integrated sensing and communication capability, the core network device may send sensing resource configuration information through a radio access network message. Optionally, in some embodiments of the present disclosure, in a case where the core network device supports the integrated sensing and communication capability, the access network device may send the sensing resource configuration information to the terminal, and the sensing resource configuration information is used to provide the terminal with the integrated sensing and communication system parameters.

It should be noted that in embodiments of the present disclosure, the sensing resource configuration information may be stored in the core network device, or the sensing resource configuration information may also be stored in the access network device.

In an implementation, in a case where the sensing resource configuration information is stored on the core network device, the access network device may receive the sensing resource configuration information sent by the core network device and send the sensing resource configuration information to the terminal through SI or an RRC message.

That is, in a case where the core network device determines that it supports the integrated sensing and communication capability and the sensing resource configuration information is stored on the core network device, the core network device may send the sensing resource configuration information to the access network device. The access network device sends the sensing resource configuration information to the terminal through the SI or the RRC messages. For example, the access network device may send the sensing resource configuration information to the terminal in a form of broadcast through a system message. Alternatively, the access network device may also send the sensing resource configuration information to the terminal through the RRC message dedicated to the terminal. Alternatively, the access network may also send the sensing resource configuration information to the terminal in other ways, which is not limited in embodiments of the present disclosure and will not be repeated here.

In another implementation, in a case where the sensing resource configuration information is stored on the access network device, the access network device receives first information sent by the core network device, in which the first information indicates the access network device to send the sensing resource configuration information to the terminal. The access network device sends the sensing resource configuration information to the terminal through the SI or the RRC messages.

That is, in a case where the core network device determines that it supports the integrated sensing and communication capability, and the sensing resource configuration information is stored on the access network device, the core network device may send the first information to the access network device to indicate the access network device to send the stored sensing resource configuration information to the terminal. For example, the access network device may send the sensing resource configuration information to the terminal in the form of broadcast through a system message. Alternatively, the access network device may also send the sensing resource configuration information to the terminal through the RRC message dedicated to the terminal. Alternatively, the access network may also send the sensing resource configuration information to the terminal in other ways, which is not limited in embodiments of the present disclosure and will not be repeated here.

In a possible implementation, the integrated sensing and communication system parameter may include, but is not limited to, at least one of: a carrier frequency; a count of subcarriers; a count of estimating symbols; a bandwidth; a subcarrier spacing; a complete OFDM symbol period; a cyclic prefix period; an OFDM symbol period; or a cyclic prefix length.

By implementing the embodiments of the present disclosure, the information indicating whether the terminal supports the integrated sensing and communication capability and the information indicating whether the network supports the integrated sensing and communication capability may be added in the registration procedure, such that the terminal and the network may determine whether the other supports the integrated sensing and communication capability during the registration procedure, and such that when both the network and the terminal support the integrated sensing and communication capability, the network performs configuration of, for example, sensing measurement on the terminal, to realize the function of sensing the communication environment.

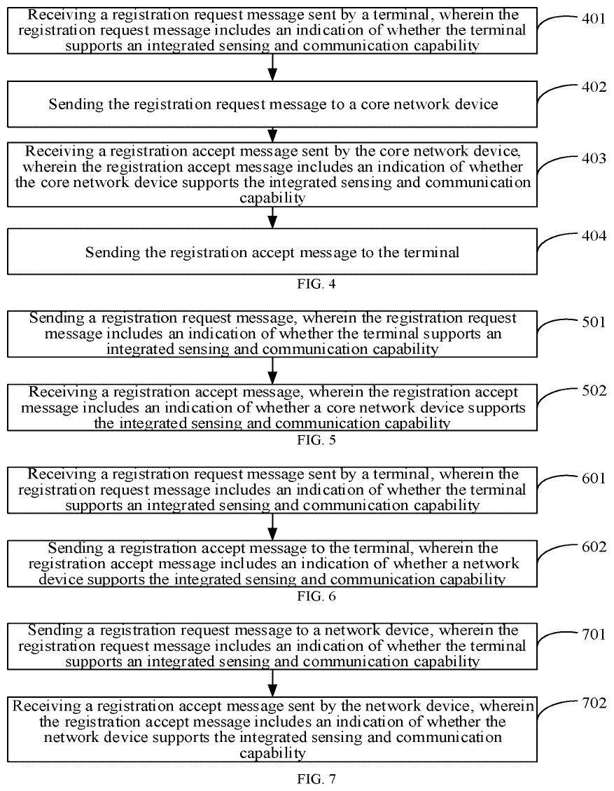

It may be understood that the above-described embodiments describe the implementation of the registration method of the embodiments of the present disclosure from the core network device side and the access network device side respectively. The embodiments of the present disclosure further provide a registration method, and an implementation of the registration method will be described below from the terminal side. Referring to FIG. 5, FIG. 5 is a flowchart illustrating yet another registration method according to embodiments of the present disclosure. It should be noted that the method may be performed by a terminal. As shown in FIG. 5, the method may include but is not limited to following steps.

In step S501, a registration request message is sent, in which the registration request message includes an indication of whether a terminal supports an integrated sensing and communication capability.

In an example of the present disclosure, the terminal may directly send the registration request message to the core network device.

In an example of the present disclosure, the registration request message is sent by the terminal to the core network device through an access network device. For example, the terminal may send the registration request message to the access network device, and the access network device may forward the registration request message to the core network device.

Optionally, in embodiments of the present disclosure, the terminal may determine whether it supports the integrated sensing and communication capability. As an example, the terminal may determine whether the terminal includes hardware providing a sensing function and hardware providing a communication function through its own hardware parameters. If the terminal includes the hardware providing the sensing function and the hardware providing the communication function, it is determined that the terminal supports the integrated sensing and communication capability. If the terminal does not include the hardware providing the sensing function and/or the hardware providing the communication function, it is determined that the terminal does not support the integrated sensing and communication capability.

For example, the terminal initiates a registration, that is, the terminal sends an AN message to the access network device (such as a base station), and the message includes an AN parameter and the registration request message, in which the registration request message includes at least an indication of whether the terminal supports the integrated sensing and communication capability. The access network device performs an AMF selection. The AN sends an N2 message to the selected AMF, in which the N2 message includes an N2 parameter and the registration request message. In a case where the AMF receives the N2 message including the registration request message, the AMF executes an AUSF selection to continue a subsequent registration procedure, in which the subsequent registration procedure (process steps other than a registration accept stage) is the same as the existing registration procedure in the related art, which is not specifically limited in embodiments of the present disclosure and will not be repeated here.

Optionally, in some embodiments of the present disclosure, a network registration type may include multiple different types of registrations. For example, taking a 5G network as an example, the registration type of the 5G network may include an initial registration, a mobility update registration, and a periodic registration. In an implementation, the registration procedure described in the embodiments of the present disclosure may include, but is not limited to, any one of the initial registration, the mobility update registration, and the periodic registration.

In an implementation, a first indication field having a given size is included in the registration request message, and the first indication field indicates whether the terminal supports the integrated sensing and communication capability. That is, an indication field is added to the registration request message in the registration procedure, and the indication field is used to identify whether the terminal supports the integrated sensing and communication capability (or has the integrated sensing and communication capability). For example, the indication field may be a bit, and a value of the bit is “1”, which may identify that the terminal supports the integrated sensing and communication capability. The value of the bit is “0”, which may identify that the terminal does not support the integrated sensing and communication capability. Alternatively, the value of the bit is “0”, which may indicate that the terminal supports the integrated sensing and communication capability; and the value of the bit is “1”, which may identify that the terminal does not support the integrated sensing and communication capability. It should be noted that the value of the bit may be another numerical value for identifying whether the terminal supports the integrated sensing and communication capability, which is not specifically limited in this disclosure and will not be repeated here.

In step S502, a registration accept message is received, in which the registration accept message includes an indication of whether the core network device supports the integrated sensing and communication capability.

In an example of the present disclosure, the registration accept message may be directly sent by the core network device to the terminal.

In an example of the present disclosure, the registration accept message is sent by the core network device to the terminal through the access network device. For example, the core network device may send the registration accept message to the access network device, and the access network device may forward the registration accept message to the terminal.

Optionally, in embodiments of the present disclosure, the core network device may determine whether it supports the integrated sensing and communication capability. In a case where the core network device accepts a registration request in the registration procedure, the core network device may send the registration accept message to the terminal through the access network device, in which the registration accept message may include an indication of whether the core network device supports the integrated sensing and communication capability. That is, in a registration accept stage of the registration procedure, the present disclosure indicates whether the core network device supports the integrated sensing and communication capability by adding the indication information to the registration accept message. In this way, the terminal may know whether a network supports the integrated sensing and communication capability through the registration accept message, such that the terminal may subsequently obtain the configuration of the sensing measurement from the network and report a sensing measurement result to the network.

As an example, the accepted registration request may be a REGISTRATION ACCEPT message. For example, in a case where the core network device sends the REGISTRATION ACCEPT message to the terminal through the access network device, indication information for indicating whether the core network device supports the integrated sensing and communication capability may be added to the REGISTRATION ACCEPT message. In this way, in a case where the terminal receives the REGISTRATION ACCEPT message, the terminal may determine whether the core network device supports the integrated sensing and communication capability according to the REGISTRATION ACCEPT message.

In a possible implementation, in a case where the core network device accepts the registration request, the core network device sends the REGISTRATION ACCEPT message to the access network device, and indication information for indicating whether the core network device supports the integrated sensing and communication capability may be added to the REGISTRATION ACCEPT message. In a case where the access network device receives the REGISTRATION ACCEPT message, it may send the REGISTRATION ACCEPT message to the terminal. Since the information indicating whether the core network device supports the integrated sensing and communication capability is added in the REGISTRATION ACCEPT message, the terminal may determine whether the core network device supports the integrated sensing and communication capability according to the received REGISTRATION ACCEPT message. For example, in a case where the core network device supports the integrated sensing and communication capability, it may be determined that the access network device also supports the integrated sensing and communication capability.

In an implementation, a second indication field having a given size is included in the registration accept message, and the second indication field indicates whether the core network device supports the integrated sensing and communication capability. That is, an indication field may be added to the registration accept message, and the indication field is used to identify whether the core network device supports the integrated sensing and communication capability (or has the integrated sensing and communication capability). For example, the indication field may be a bit, and a value of the bit is “1”, which may identify that the core network device supports the integrated sensing and communication capability. The value of the bit is “0”, which may identify that the core network device does not support the integrated sensing and communication capability. Alternatively, the value of the bit is “0”, which may indicate that the core network device supports the integrated sensing and communication capability; and the value of the bit is “1”, which may identify that the core network device does not support the integrated sensing and communication capability. It should be noted that the value of the bit may be another numerical value for identifying whether the core network device supports the integrated sensing and communication capability, which is not specifically limited in the present disclosure and will not be repeated here.

It should be noted that in a case where both the network and the terminal support the sensing capability, the network may issue sensing resource configuration information for the terminal to perform a sensing measurement. Optionally, in some embodiments of the present disclosure, the terminal may receive the sensing resource configuration information. In an example of the present disclosure, the terminal may receive the sensing resource configuration information sent by the access network device, and the sensing resource configuration information is used to provide integrated sensing and communication system parameters for the terminal.

In embodiments of the present disclosure, the access network device may issue the sensing resource configuration information through a system message or an RRC message. In an implementation, the terminal may receive the sensing resource configuration information sent by the access network device through the SI. In another implementation, the terminal may receive the sensing resource configuration information sent by the access network device through the RRC message. For example, the terminal may receive the sensing resource configuration information sent by the access network device through the RRC message dedicated to the terminal. In this way, in a case where the terminal receives the sensing resource configuration information, the terminal may perform the sensing measurement. Optionally, the terminal may further report the sensing measurement result to the network.

In a possible implementation, the integrated sensing and communication system parameter may include, but is not limited to, at least one of: a carrier frequency; a count of subcarriers; a count of estimating symbols; a bandwidth; a subcarrier spacing; a complete OFDM symbol period; a cyclic prefix period; an OFDM symbol period; or a cyclic prefix length. For the implementation of the integrated sensing and communication system parameter, please refer to the implementation of the integrated sensing and communication system parameter in the embodiments of the registration method described above from the core network device side, and the description thereof will not be repeated here.

By implementing the embodiments of the present disclosure, the information indicating whether the terminal supports the integrated sensing and communication capability and the information indicating whether the network supports the integrated sensing and communication capability may be added in the registration procedure, such that the terminal and the network may determine whether the other supports the integrated sensing and communication capability during the registration procedure, and such that when both the network and the terminal support the integrated sensing and communication capability, the network performs configuration of, for example, sensing measurement on the terminal, to realize the function of sensing the communication environment.

Embodiments of the present disclosure further provides another registration method. Referring to FIG. 6, FIG. 6 is a flowchart illustrating another registration method according to embodiments of the present disclosure. It should be noted that the method may be performed by a network device, in which the network device may be a device integrating an access network function and a core network function. As shown in FIG. 6, the method may include but is not limited to following steps.

In step S601, a registration request message sent by a terminal is received, in which the registration request message includes an indication of whether the terminal supports an integrated sensing and communication capability.

Optionally, in embodiments of the present disclosure, the terminal may determine whether it supports the integrated sensing and communication capability. As an example, the terminal may determine whether the terminal includes hardware providing a sensing function and hardware providing a communication function through its own hardware parameters. If the terminal includes the hardware providing the sensing function and the hardware providing the communication function, it is determined that the terminal supports the integrated sensing and communication capability. If the terminal does not include the hardware providing the sensing function and/or the hardware providing the communication function, it is determined that the terminal does not support the integrated sensing and communication capability.

For example, the terminal initiates a registration, that is, the terminal sends the registration request message to the network device, which includes an indication of whether the terminal supports the integrated sensing and communication capability. In this way, the network device receives the registration request message sent by the terminal, and may determine whether the terminal supports the integrated sensing and communication capability through the registration request message.

In an implementation, a first indication field having a given size is included in the registration request message, and the first indication field indicates whether the terminal supports the integrated sensing and communication capability. That is, an indication field is added to the registration request message in the registration procedure, and the indication field is used to identify whether the terminal supports the integrated sensing and communication capability (or has the integrated sensing and communication capability). For example, the indication field may be a bit, and a value of the bit is “1”, which may identify that the terminal supports the integrated sensing and communication capability. The value of the bit is “0”, which may identify that the terminal does not support the integrated sensing and communication capability. Alternatively, the value of the bit is “0”, which may indicate that the terminal supports the integrated sensing and communication capability; and the value of the bit is “1”, which may identify that the terminal does not support the integrated sensing and communication capability. It should be noted that the value of the bit may be another numerical value for identifying whether the terminal supports the integrated sensing and communication capability, which is not specifically limited in this disclosure and will not be repeated here.

In step S602, a registration accept message is sent to the terminal, in which the registration accept message includes an indication of whether the network device supports the integrated sensing and communication capability.

Optionally, in embodiments of the present disclosure, the network device may determine whether it supports the integrated sensing and communication capability. In a case where the network device accepts the registration request in the registration procedure, the network device may send the registration accept message to the terminal, which includes an indication of whether the network device supports the integrated sensing and communication capability.

In an implementation, a second indication field having a given size is included in the registration accept message, and the second indication field indicates whether the network device supports the integrated sensing and communication capability. That is, an indication field may be added to the registration accept message, and the indication field is used to identify whether the network device supports the integrated sensing and communication capability (or has the integrated sensing and communication capability). For example, the indication field may be a bit, and a value of the bit is “1”, which may identify that the network device supports the integrated sensing and communication capability. The value of the bit is “0”, which may identify that the network device does not support the integrated sensing and communication capability. Alternatively, the value of the bit is “0”, which may indicate that the network device supports the integrated sensing and communication capability; and the value of the bit is “1”, which may identify that the network device does not support the integrated sensing and communication capability. It should be noted that the value of the bit may be another numerical value for identifying whether the network device supports the integrated sensing and communication capability, which is not specifically limited in this disclosure and will not be repeated here.

It should be noted that in a case where both the network device and the terminal support the sensing capability, the network device may issue sensing resource configuration information for the terminal to perform a sensing measurement. Optionally, in some embodiments of the present disclosure, the network device determines that it supports the integrated sensing and communication capability. The network device sends the sensing resource configuration information to the terminal, and the sensing resource configuration information is used to provide integrated sensing and communication system parameters for the terminal.

In a possible implementation, the integrated sensing and communication system parameters may include, but are not limited to, at least one of: a carrier frequency; a count of subcarriers; a count of estimating symbols; a bandwidth; a subcarrier spacing; a complete OFDM symbol period; a cyclic prefix period; an OFDM symbol period; or a cyclic prefix length. For the implementation of the integrated sensing and communication system parameter, please refer to the implementation of the integrated sensing and communication system parameter in the embodiments of the registration method described above from the core network device side, and the description thereof will not be repeated here.

By implementing the embodiments of the present disclosure, the information indicating whether the terminal supports the integrated sensing and communication capability and the information indicating whether the network supports the integrated sensing and communication capability may be added in the registration procedure, such that the terminal and the network may determine whether the other supports the integrated sensing and communication capability during the registration procedure, and such that when both the network device and the terminal support the integrated sensing and communication capability, the network device performs configuration of, for example, sensing measurement on the terminal, to realize the function of sensing the communication environment.

It may be understood that the above-described embodiments describe an implementation of the registration method of the embodiments of the present disclosure from the network device side. The embodiments of the present disclosure further provide a registration method, and an implementation of the registration method will be described below from the terminal side. Referring to FIG. 7, FIG. 7 is a flowchart illustrating yet another registration method according to embodiments of the present disclosure. It should be noted that the registration method of the embodiments of the present disclosure may be performed by a terminal. As shown in FIG. 7, the method may include but is not limited to following steps.

In step S701, a registration request message is sent to a network device, in which the registration request message includes an indication of whether a terminal supports an integrated sensing and communication capability.

In embodiments of the present disclosure, the network device may be a device that integrates an access network function and a core network function.

Optionally, in embodiments of the present disclosure, the terminal may determine whether it supports the integrated sensing and communication capability. As an example, the terminal may determine whether the terminal includes hardware providing a sensing function and hardware providing a communication function through its own hardware parameters. If the terminal includes the hardware providing the sensing function and the hardware providing the communication function, it is determined that the terminal supports the integrated sensing and communication capability. If the terminal does not include the hardware providing the sensing function and/or the hardware providing the communication function, it is determined that the terminal does not support the integrated sensing and communication capability.

For example, the terminal initiates a registration, that is, the terminal sends the registration request message to the network device, which includes an indication of whether the terminal supports the integrated sensing and communication capability. In this way, the network device receives the registration request message sent by the terminal, and may determine whether the terminal supports the integrated sensing and communication capability through the registration request message.

In an implementation, a first indication field having a given size is included in the registration request message, and the first indication field indicates whether the terminal supports the integrated sensing and communication capability. That is, an indication field is added to the registration request message in the registration procedure, and the indication field is used to identify whether the terminal supports the integrated sensing and communication capability (or has the integrated sensing and communication capability). For example, the indication field may be a bit, and a value of the bit is “1”, which may identify that the terminal supports the integrated sensing and communication capability. The value of the bit is “0”, which may identify that the terminal does not support the integrated sensing and communication capability. Alternatively, the value of the bit is “0”, which may indicate that the terminal supports the integrated sensing and communication capability; and the value of the bit is “1”, which may identify that the terminal does not support the integrated sensing and communication capability. It should be noted that the value of the bit may be another numerical value for identifying whether the terminal supports the integrated sensing and communication capability, which is not specifically limited in this disclosure and will not be repeated here.

In step S702, a registration accept message sent by the network device is received, in which the registration accept message includes an indication of whether the network device supports the integrated sensing and communication capability.

Optionally, in embodiments of the present disclosure, the network device may determine whether it supports the integrated sensing and communication capability. In a case where the network device accepts the registration request in the registration procedure, the network device may send the registration accept message to the terminal, which includes an indication of whether the network device supports the integrated sensing and communication capability. In this way, the terminal receives the registration accept message sent by the network device, and determines whether the network device supports the integrated sensing and communication capability through the registration accept message.

In an implementation, a second indication field having a given size is included in the registration accept message, and the second indication field indicates whether the network device supports the integrated sensing and communication capability. That is, an indication field may be added to the registration accept message, and the indication field is used to identify whether the network device supports the integrated sensing and communication capability (or has the integrated sensing and communication capability). For example, the indication field may be a bit, and a value of the bit is “1”, which may identify that the network device supports the integrated sensing and communication capability. The value of the bit is “0”, which may identify that the network device does not support the integrated sensing and communication capability. Alternatively, the value of the bit is “0”, which may indicate that the network device supports the integrated sensing and communication capability; and the value of the bit is “1”, which may identify that the network device does not support the integrated sensing and communication capability. It should be noted that the value of the bit may be another numerical value for identifying whether the network device supports the integrated sensing and communication capability, which is not specifically limited in this disclosure and will not be repeated here.

It should be noted that in a case where both the network device and the terminal support the sensing capability, the network device may issue sensing resource configuration information for the terminal to perform sensing measurement. Optionally, in some embodiments of the present disclosure, the terminal may receive the sensing resource configuration information sent by the network device, and the sensing resource configuration information is used to provide integrated sensing and communication system parameters for the terminal.

In a possible implementation, the integrated sensing and communication system parameters may include, but are not limited to, at least one of: a carrier frequency; a count of subcarriers; a count of estimating symbols; a bandwidth; a subcarrier spacing; a complete OFDM symbol period; a cyclic prefix period; an OFDM symbol period; or a cyclic prefix length. For the implementation of the integrated sensing and communication system parameter, please refer to the implementation of the integrated sensing and communication system parameter in the embodiments of the registration method described above from the core network device side, and the description thereof will not be repeated here.

By implementing the embodiments of the present disclosure, the information indicating whether the terminal supports the integrated sensing and communication capability and the information indicating whether the network supports the integrated sensing and communication capability may be added in the registration procedure, such that the terminal and the network may determine whether the other supports the integrated sensing and communication capability during the registration procedure, and such that when both the network device and the terminal support the integrated sensing and communication capability, the network configures the terminal for performing sensing measurement, so as to realize the function of sensing the communication environment.

In the above embodiments provided by the present disclosure, the methods provided by the embodiments of the present disclosure are described from the perspectives of a core network device, an access network device, a terminal, and a network device, respectively. In order to realize each function in the method provided by the above-described embodiments of the present disclosure, the core network device, the access network device, the terminal, and the network device may include a hardware structure and a software module, and implement each function in the form of a hardware structure, a software module, or a hardware structure plus a software module. Some of the above functions may be executed in a hardware structure, a software module, or a hardware structure plus a software module.

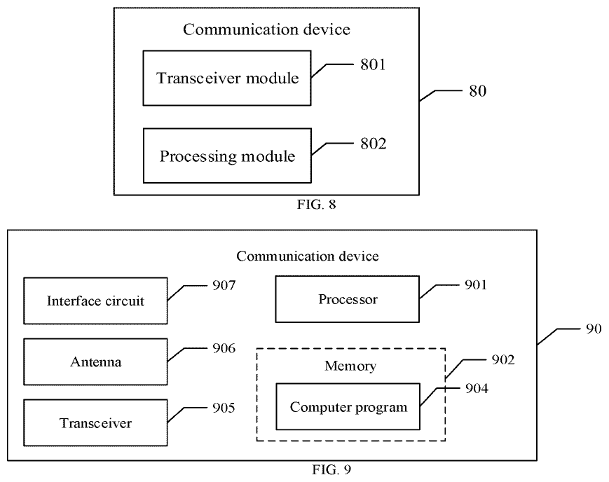

Referring to FIG. 8, FIG. 8 is a schematic block diagram illustrating a communication device 80 according to embodiments of the present disclosure. The communication device 80 shown in FIG. 8 may include a transceiver module 801 and a processing module 802. The transceiver module 801 may include a sending module and/or a receiving module. The sending module is configured to implement a sending function, and the receiving module is configured to implement a receiving function. The transceiver module 801 may implement a sending function and/or a receiving function.

The communication device 80 may be a core network device, or may be an apparatus in a core network device, or may be an apparatus that may be used in cooperation with a core network device.

The communication device 80 is a core network device:
the transceiver module 801 is configured to receive a registration request message, in which the registration request message includes an indication of whether a terminal supports an integrated sensing and communication capability; and
the transceiver module 801 is further configured to send a registration accept message, in which the registration accept message includes an indication of whether a core network device supports the integrated sensing and communication capability.

In an implementation, the processing module 802 is configured to determine that the core network device supports the integrated sensing and communication capability. The transceiver module 801 is further configured to send sensing resource configuration information to the terminal, in which the sensing resource configuration information is used to provide an integrated sensing and communication system parameter for the terminal.

In a possible implementation, the sensing resource configuration information is stored on the core network device. The transceiver module 801 is further configured to send the sensing resource configuration information to an access network device to enable that the sensing resource configuration information is sent by the access network device to the terminal through SI or an RRC message.

In a possible implementation, the sensing resource configuration information is stored on the access network device. The transceiver module 801 is further configured to send first information to an access network device, in which the first information indicates the access network device to send the sensing resource configuration information to the terminal.

In some embodiments of the present disclosure, the integrated sensing and communication system parameter includes at least one of: a carrier frequency; a count of subcarriers; a count of estimating symbols; a bandwidth; a subcarrier spacing; a complete OFDM symbol period; a cyclic prefix period; an OFDM symbol period; or a cyclic prefix length.

In some embodiments of the present disclosure, a first indication field having a given size is included in the registration request message, in which the first indication field indicates whether the terminal supports the integrated sensing and communication capability; and/or a second indication field having a given size is included in the registration request message, in which the second indication field indicates whether the core network device supports the integrated sensing and communication capability.

The communication device 80 may be an access network device, or may be an apparatus in an access network device, or may be an apparatus that may be used in cooperation with an access network device.

The communication device 80 is an access network device:
the transceiver module 801 is configured to receive a registration request message sent by a terminal, in which the registration request message includes an indication of whether the terminal supports an integrated sensing and communication capability. The transceiver module 801 is further configured to send the registration request message to a core network device. The transceiver module 801 is further configured to receive a registration accept message sent by the core network device, in which the registration accept message includes an indication of whether the core network device supports the integrated sensing and communication capability. The transceiver module 801 is further configured to send the registration accept message to the terminal.

In an implementation, the transceiver module 801 is further configured to send sensing resource configuration information to the terminal in a case where the core network device supports the integrated sensing and communication capability, in which the sensing resource configuration information is used to provide an integrated sensing and communication system parameter for the terminal.

In a possible implementation, the sensing resource configuration information is stored on the core network device. The transceiver module 801 is further configured to receive the sensing resource configuration information sent by a core network device, and send the sensing resource configuration information to the terminal through SI or an RRC message.

In a possible implementation, the sensing resource configuration information is stored on the access network device. The transceiver module 801 is further configured to receive first information sent by the core network device, in which the first information indicates the access network device to send the sensing resource configuration information to the terminal.

In some embodiments of the present disclosure, the integrated sensing and communication system parameter includes at least one of: a carrier frequency; a count of subcarriers; a count of estimating symbols; a bandwidth; a subcarrier spacing; a complete OFDM symbol period; a cyclic prefix period; an OFDM symbol period; or a cyclic prefix length.

In some embodiments of the present disclosure, a first indication field having a given size is included in the registration request message, in which the first indication field indicates whether the terminal supports the integrated sensing and communication capability; and/or a second indication field having a given size is included in the registration request message, in which the second indication field indicates whether the core network device supports the integrated sensing and communication capability.

The communication device 80 may be a terminal, or may be an apparatus in a terminal, or may be an apparatus that may be used in cooperation with a terminal.

The communication device 80 is a terminal:

the transceiver module 801 is configured to send a registration request message, in which the registration request message includes an indication of whether a terminal supports an integrated sensing and communication capability; and the transceiver module 801 is further configured to receive a registration accept message, in which the registration accept message includes an indication of whether a core network device supports the integrated sensing and communication capability.

In an implementation, the transceiver module 801 is further configured to receive sensing resource configuration information, in which the sensing resource configuration information is used to provide an integrated sensing and communication system parameter for the terminal.

In an implementation, the transceiver module 801 is specifically configured to receive the sensing resource configuration information sent by an access network device through SI; or receive the sensing resource configuration information sent by an access network device through an RRC message.

In some embodiments of the present disclosure, the integrated sensing and communication system parameter includes at least one of: a carrier frequency; a count of subcarriers; a count of estimating symbols; a bandwidth; a subcarrier spacing; a complete OFDM symbol period; a cyclic prefix period; an OFDM symbol period; or a cyclic prefix length.

In some embodiments of the present disclosure, a first indication field having a given size is included in the registration request message, in which the first indication field indicates whether the terminal supports the integrated sensing and communication capability; and/or a second indication field having a given size is included in the registration request message, in which the second indication field indicates whether the core network device supports the integrated sensing and communication capability.

The communication device 80 may be a network device, or may be an apparatus in a network device, or may be an apparatus that may be used in cooperation with a network device.

The communication device 80 is a network device:
the transceiver module 801 is configured to receive a registration request message sent by a terminal, in which the registration request message includes an indication of whether a terminal supports an integrated sensing and communication capability; and
the transceiver module 801 is further configured to send a registration accept message to a terminal, in which the registration accept message includes an indication of whether the communication device supports the integrated sensing and communication capability.

In an implementation, the processing module 802 is configured to determine that the network device supports the integrated sensing and communication capability. The transceiver module 801 is further configured to send sensing resource configuration information to the terminal, in which the sensing resource configuration information is used to provide an integrated sensing and communication system parameter for the terminal.

In some embodiments of the present disclosure, the integrated sensing and communication system parameter includes at least one of: a carrier frequency; a count of subcarriers; a count of estimating symbols; a bandwidth; a subcarrier spacing; a complete OFDM symbol period; a cyclic prefix period; an OFDM symbol period; or a cyclic prefix length.

In some embodiments of the present disclosure, a first indication field having a given size is included in the registration request message, in which the first indication field indicates whether the terminal supports the integrated sensing and communication capability; and/or a second indication field having a given size is included in the registration request message, in which the second indication field indicates whether the core network device supports the integrated sensing and communication capability.

The communication device 80 may be a terminal, or may be an apparatus in a terminal, or may be an apparatus that may be used in cooperation with a terminal.

The communication device 80 is on the terminal side:

the transceiver module 801 is configured to send a registration request message to a network device, in which the registration request message includes an indication of whether a terminal supports an integrated sensing and communication capability; and the transceiver module 801 is further configured to receive a registration accept message sent by the network device, in which the registration accept message includes an indication of whether the network device supports the integrated sensing and communication capability.

In an implementation, the transceiver module 801 is further configured to receive sensing resource configuration information sent by the network device, in which the sensing resource configuration information is used to provide an integrated sensing and communication system parameter for the terminal.

In some embodiments of the present disclosure, the integrated sensing and communication system parameter includes at least one of: a carrier frequency; a count of subcarriers; a count of estimating symbols; a bandwidth; a subcarrier spacing; a complete OFDM symbol period; a cyclic prefix period; an OFDM symbol period; or a cyclic prefix length.

In some embodiments of the present disclosure, a first indication field having a given size is included in the registration request message, in which the first indication field indicates whether the terminal supports the integrated sensing and communication capability; and/or a second indication field having a given size is included in the registration request message, in which the second indication field indicates whether the core network device supports the integrated sensing and communication capability.

With regard to the apparatus in the above-described embodiments, the specific manner in which the respective modules perform operations has been described in detail in the embodiments related to the method, and will not be described in detail here.

Referring to FIG. 9, FIG. 9 is a schematic block diagram illustrating another communication device 90 according to embodiments of the present disclosure. The communication device 90 may be configured to implement the method as described in above method embodiments, with particular reference to the description of method embodiments described above.

The communication device 90 may include one or more processors 901. The processor 901 may be a general-purpose processor or a special-purpose processor, etc. It may be, for example, a baseband processor or a central processor. The baseband processor may be configured to process a communication protocol and communication data, and the central processor may be configured to control a communication device (such as a base station, a baseband chip, a terminal, a terminal chip, a DU or a CU, etc.), execute a computer program and process data of the computer program.

Optionally, the communication device 90 may further include one or more memories 902 on which the computer program 904 may be stored, and the memory 902 executes the computer program 904 to cause the communication device 90 to perform the method as described in above method embodiments. In some possible implementations, the memory 902 may also have the data stored therein. The communication device 90 and the memory 902 may be provided independently or integrated together.

Optionally, the communication device 90 may further include a transceiver 905 and an antenna 906. The transceiver 905 may be referred to as a transceiver unit, a transceiver machine, or a transceiver circuit for implementing a transceiving function. The transceiver 905 may include a receiver and a transmitter, the receiver may be referred to as a receiving machine or a receiving circuit or the like for implementing a receiving function; and the transmitter may be referred to as a transmitting machine or a transmission circuit or the like for implementing a transmitting function.

Optionally, the communication device 90 may further include one or more interface circuits 907. The interface circuit 907 is configured to receive code instructions and transmit the code instructions to the processor 901. The processor 901 executes the code instructions to cause the communication device 90 to perform the method described in above method embodiments.

The communication device 90 may be a core network device, a chip, a chip system, a processor, or the like that supports the core network device to implement the above-described method. The communication device 90 is on the core network device, in which: the transceiver 905 is configured to perform steps 201 and 202 in FIG. 2; or perform steps 301, 303, and 304 in FIG. 3. The processor 901 is configured to perform step 302 in FIG. 3.

The communication device 90 may be an access network device, or may be a chip, a chip system, a processor, or the like that supports the access network device to implement the above-described method. The communication device 90 is on the access network device, in which the transceiver 905 is configured to perform steps 401, 402, 403 and 404 in FIG. 4.

The communication device 90 may be a terminal, or may be a chip, a chip system, a processor, or the like that supports the terminal to implement the above-described method. The communication device 90 is on the terminal, in which the transceiver 905 is configured to perform steps 501 and 502 in FIG. 5.

The communication device 90 may be a network device, or may be a chip, a chip system, a processor, or the like that supports the network device to implement the above-described method. The communication device 90 is on the network device, in which the transceiver 905 is configured to perform steps 601 and 602 in FIG. 6.

The communication device 90 may be a terminal, or may be a chip, a chip system, a processor, or the like that supports the terminal to implement the above-described method. The communication device 90 is on the terminal, and the transceiver 905 is configured to perform steps 701 and 702 in FIG. 7.

In an implementation, the processor 901 may further include the transceiver for implementing receiving and transmitting functions. For example, the transceiver may be a transceiver circuit, or an interface, or an interface circuit. The transceiver circuit, interface, or interface circuit for implementing the receiving and transmitting functions may be separated or integrated. The transceiver circuit, interface or interface circuit may be configured to read and write code/data, or the transceiver circuit, interface or interface circuit may be configured for transmission or transfer of signals.

In an implementation, the processor 901 may have stored therein the computer program that, when run on the processor 901, causes the communication device 90 to perform the method described in above method embodiments. The computer program may be solidified in the processor 901, in which case the processor 901 may be implemented in hardware.

In an implementation, the communication device 90 may include a circuit that may implement a transmitting, receiving or communicating function in foregoing method embodiments. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be fabricated with various IC process technologies such as complementary metal oxide semiconductor (CMOS), n-metal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device in above embodiments may be the network device or the terminal, but the scope of the communication device described in the present disclosure is not limited thereto. Moreover, the structure of the communication device may not be limited by FIG. 9. The communication device may be a stand-alone device or may be a part of a larger device. For example, the communication device may be:
(1) a stand-alone integrated circuit (IC), or a chip, or a chip system or a subsystem;
(2) a set of one or more ICs, optionally the set of ICs may also include a storage component for storing the data and the computer program;
(3) ASIC, such as modem;
(4) a module that may be embedded in other devices;
(5) a receiver, a terminal, an intelligent terminal, a cellular phone, a wireless device, a handset, a mobile unit, an on-vehicle device, a network device, a cloud device, an artificial intelligence device, etc.; or
(6) others.

Those skilled in the art may further appreciate that the various illustrative logical blocks and steps described in embodiments of the present disclosure may be implemented in electronic hardware, computer software, or combinations of both. Whether such functionality is implemented as hardware or software depends upon particular application and design requirement of the overall system. Those skilled in the art may implement the described functionality in varying ways for each particular application, but such implementation should not be considered to be beyond the scope of protection of embodiments of the present disclosure.

Embodiments of the present disclosure further provide a communication system, the system includes the communication device as the terminal, the communication device as the core network device and the communication device as the access network device described in forgoing embodiments of FIG. 8, or the communication device as the network device and the communication device as the terminal described in forgoing embodiments of FIG. 8, or the system includes the communication device as the terminal and the communication device as the network device described in forgoing embodiments of FIG. 9, or the communication device as the network device and the communication device as the terminal described in forgoing embodiments of FIG. 9.

Embodiments of the present disclosure further provide a communication system including a core network device, an access network device, and a terminal. The core network device is configured to execute the registration method shown in the embodiment of FIGS. 2 and 3. The access network device is configured to perform the registration method shown in the embodiment of FIG. 4. The terminal device is configured to perform the registration method shown in the embodiment of FIG. 5.

Embodiments of the present disclosure further provides another communication system, which includes a network device and a terminal. The network device is configured to perform the registration method shown in the embodiments of FIG. 6. The terminal is configured to perform the registration method shown in the embodiments of FIG. 7.

The present disclosure further provides a readable storage medium having instructions stored thereon that, when executed by a computer, causes the functions of any of the method embodiments described above to be implemented.

The present disclosure also provides a computer program product that, when executed by a computer, causes the functions of any of the method embodiments described above to be implemented.

The above embodiments may be implemented in whole or in part by software, hardware, firmware or any combination thereof. When implemented using the software, the above embodiments may be implemented in whole or in part in a form of the computer program product. The computer program product includes one or more computer programs. When the computer programs are loaded and executed on the computer, all or part of the processes or functions according to embodiments of the present disclosure will be generated. The computer may be a general purpose computer, a special purpose computer, a computer network, or other programmable devices. The computer programs may be stored in a computer-readable storage medium or transmitted from one computer-readable storage medium to another computer-readable storage medium. For example, the computer programs may be transmitted from one website site, computer, server or data center to another website site, computer, server or data center in a wired manner (such as via a coaxial cable, an optical fiber, a digital subscriber line (DSL)) or a wireless manner (such as via infrared, wireless, or microwave, etc.). The computer-readable storage medium may be any available medium that may be accessed by the computer, or a data storage device such as a server or a data center integrated by one or more available media. The available medium may be a magnetic medium (for example, a floppy disk, a hard disk, or a magnetic tape), an optical medium (for example, a high-density digital video disc (DVD)), or a semiconductor medium (for example, a solid state disk (SSD)), etc.

Those of ordinary skill in the art may understand that the first, second, and other numeral numbers involved in the present disclosure are for convenience of description, and are not intended to limit the scope of embodiments of the present disclosure, nor are they intended to represent a sequential order.

The term “at least one” used in the present disclosure may also be described as one or more, and the term “a plurality of” may cover two, three, four or more which is not limited in the present disclosure. In embodiments of the present disclosure, for a certain kind of technical features, the technical features in this kind of technical features are distinguished by terms like “first”, “second”, “third”, “A”, “B”, “C” and “D”, etc., and these technical features described with the “first”, “second”, “third”, “A”, “B”, “C” and “D” have no order of priority and have no order of size.

The correspondence shown in each table in the present disclosure may be configured or predefined. The values of various information in each table are examples, and may be configured as other values, which are not limited in the present disclosure. When configuring a correspondence between the information and various parameters, it is not necessary to configure all the correspondences shown in the tables. For example, the correspondences shown in some rows of a table in the present disclosure may not be configured. For another example, appropriate deformations or adjustments (such as splitting, merging, and so on) may be made based on the above table. The names of parameters shown in the titles of the above tables may adopt other names understandable by the communication device, and the values or representations of the parameters may also be other values or representations understandable by the communication device. When the above tables are implemented, other data structures may also be used, for example, arrays, queues, containers, stacks, linear tables, pointers, linked lists, trees, graphs, structural body, classes, heaps, or hash tables may be used.

The term “predefined” in the present disclosure may be understood as defined, defined in advance, stored, pre-stored, pre-negotiated, pre-configured, cured, or pre-fired.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such implementation should not be considered beyond the scope of the present disclosure.

Those skilled in the art can clearly understand that for the convenience and brevity of the description, the specific working process of the above-described system, device and unit may refer to the corresponding process in the foregoing method embodiments, which will not be repeated here.

The above has described some specific embodiments of the present disclosure, but the scope of the present disclosure is not limited thereto. Any person skilled in the art may easily think of changes or substitutions within the technical scope of the present disclosure, which shall be covered by the protection scope of the present disclosure. Therefore, the protection scope of the present disclosure shall be in line with the attached claims.

1. A registration method, performed by a core network device, comprising:
receiving a registration request message, wherein the registration request message comprises an indication of whether a terminal supports an integrated sensing and communication capability; and
sending a registration accept message, wherein the registration accept message comprises an indication of whether the core network device supports the integrated sensing and communication capability.

2. The method of claim 1, further comprising:
determining that the core network device supports the integrated sensing and communication capability; and
sending sensing resource configuration information to the terminal, wherein the sensing resource configuration information is used to provide an integrated sensing and communication system parameter for the terminal.

3. The method of claim 2, wherein sending the sensing resource configuration information to the terminal comprises:
sending the sensing resource configuration information to an access network device to enable that the sensing resource configuration information is sent by the access network device to the terminal through system information (SI) or a radio resource control (RRC) message.

4. The method of claim 2, wherein sending the sensing resource configuration information to the terminal comprises:
sending first information to an access network device, wherein the first information indicates the access network device to send the sensing resource configuration information to the terminal.

5. The method of claim 2, wherein the integrated sensing and communication system parameter comprises at least one of:
a carrier frequency;
a count of subcarriers;
a count of estimating symbols;
a bandwidth;
a subcarrier spacing;
a complete orthogonal frequency division multiplexing (OFDM) symbol period;
a cyclic prefix period;
an OFDM symbol period; or
a cyclic prefix length.

6. The method of claim 1, wherein
a first indication field having a given size is comprised in the registration request message, wherein the first indication field indicates whether the terminal supports the integrated sensing and communication capability; and/or
a second indication field having a given size is comprised in the registration accept message, wherein the second indication field indicates whether the core network device supports the integrated sensing and communication capability.

7. A registration method, performed by an access network device, comprising:
receiving a registration request message sent by a terminal, wherein the registration request message comprises an indication of whether the terminal supports an integrated sensing and communication capability;
sending the registration request message to a core network device;
receiving a registration accept message sent by the core network device, wherein the registration accept message comprises an indication of whether the core network device supports the integrated sensing and communication capability; and
sending the registration accept message to the terminal.

8. The method of claim 7, further comprising:
sending sensing resource configuration information to the terminal in a case where the core network device supports the integrated sensing and communication capability, wherein the sensing resource configuration information is used to provide an integrated sensing and communication system parameter for the terminal.

9. The method of claim 8, wherein sending the sensing resource configuration information to the terminal comprises:
receiving the sensing resource configuration information sent by the core network device; and
sending the sensing resource configuration information to the terminal through system information (SI) or a radio resource control (RRC) message.

10. The method of claim 8, wherein sending the sensing resource configuration information to the terminal comprises:
receiving first information sent by the core network device, wherein the first information indicates the access network device to send the sensing resource configuration information to the terminal; and
sending the sensing resource configuration information to the terminal through an SI or an RRC message.

11. The method of claim 8, wherein the integrated sensing and communication system parameter comprises at least one of:
a carrier frequency;
a count of subcarriers;
a count of estimating symbols;
a bandwidth;
a subcarrier spacing;
a complete orthogonal frequency division multiplexing (OFDM) symbol period;
a cyclic prefix period;
an OFDM symbol period; or
a cyclic prefix length.

12. The method of claim 7, wherein
a first indication field having a given size is comprised in the registration request message, wherein the first indication field indicates whether the terminal supports the integrated sensing and communication capability; and/or
a second indication field having a given size is comprised in the registration accept message, wherein the second indication field indicates whether the core network device supports the integrated sensing and communication capability.

13. A registration method, performed by a terminal, comprising:
sending a registration request message, wherein the registration request message comprises an indication of whether the terminal supports an integrated sensing and communication capability; and
receiving a registration accept message, wherein the registration accept message comprises an indication of whether a core network device supports the integrated sensing and communication capability.

14. The method of claim 13, further comprising:
receiving sensing resource configuration information, wherein the sensing resource configuration information is used to provide an integrated sensing and communication system parameter for the terminal.

15. The method of claim 14, wherein receiving the sensing resource configuration information comprises:
receiving the sensing resource configuration information sent by an access network device through system information (SI); or
receiving the sensing resource configuration information sent by an access network device through a radio resource control (RRC) message.

16. The method of claim 14, er 15, wherein the integrated sensing and communication system parameter comprises at least one of:
a carrier frequency;
a count of subcarriers;
a count of estimating symbols;
a bandwidth;
a subcarrier spacing;
a complete orthogonal frequency division multiplexing (OFDM) symbol period;
a cyclic prefix period;
an OFDM symbol period; or
a cyclic prefix length.

17. The method of claim 13, wherein
a first indication field having a given size is comprised in the registration request message, wherein the first indication field indicates whether the terminal supports the integrated sensing and communication capability; and/or
a second indication field having a given size is comprised in the registration accept message, wherein the second indication field indicates whether the core network device supports the integrated sensing and communication capability.

18-21. (canceled)

22. A core network device, comprising a processor and a memory, wherein the memory stores a computer program, and the processor is configured to execute the computer program stored in the memory to enable the core network device to perform the method of claim 1.

23. (canceled)

24. An access network device, comprising:
a processor; and
a memory storing instructions executable by the processor,
wherein the processor is configured to enable the access network device to perform the method of claim 7.

25. A terminal, comprising:
a processor; and
a memory storing instructions executable by the processor,
wherein the processor is configured to enable the terminal to perform the method of claim 13.
